(19) United States
(12) Patent Application Publication
(10) Pub. No.: US 2010/0104742 A1
(43) Pub. Date: Apr. 29, 2010

(54) SYSTEM, METHOD AND APPARATUS FOR A NEAT STATE LUBRICANT BLEND HAVING IMPROVED PROCESSIBILITY WITHOUT DIMINISHING PERFORMANCE OF MAGNETIC RECORDING MEDIA

(75) Inventors: Xing-Cai Guo, Tracy, CA (US); Robert Waltman, Gilroy, CA (US)

Correspondence Address: Larson Newman & Abel, LLP, 5914 West Courtyard Drive, Suite 200, Austin, TX, 78730, US

(73) Assignee: HITACHI GLOBAL STORAGE TECHNOLOGIES NETHERLANDS BV, Amsterdam (NL)

(21) Appl. No.: 12/257,550

(22) Filed: Oct. 24, 2008

(51) Int. Cl. B05D 5/00; C10M 169/04

(52) U.S. Cl. 427/127; 508/110

(57) ABSTRACT

A neat lubricant blend for magnetic media improves lubricant processibility without negatively impacting media performance. The lubricant blend combines, in their neat states, a high bonding lubricant having a molecular weight of about 2000, and a low bonding lubricant with a molecular weight below 1000. The low molecular weight lubricant evaporates after lubrication, leaving only the high molecular weight lubricant behind. Media performance such as lubricant pickup is not adversely affected. Mixing the two types of lubricants in their neat states improves solubility in the less expensive solvents.

### BACKGROUND OF THE INVENTION

1. Technical Field

The present invention relates in general to hard disk drives ands in particular, to an improved system, method and apparatus for a neat state lubricant blend for magnetic recording media in a hard disk drive.

2. Description of the Related Art

Data access and storage systems generally comprise one or more storage devices that store data on magnetic or optical storage media. For example, a magnetic storage device is known as a direct access storage device or a hard disk drive (HDD) and includes one or more disks and a disk controller to manage local operations concerning the disks. The hard disks themselves are usually made of aluminum alloy, glass or a mixture of glass and ceramic, and are covered with a magnetic coating that contains the bit pattern. Typically, one to five disks are stacked vertically on a common spindle that is turned by a disk drive motor at several thousand revolutions per minute. Hard disk drives have several different typical standard sizes or formats, including server, desktop, mobile and microdrive.

A typical HDD also uses an actuator assembly to move magnetic read/write heads to the desired location on the rotating disk so as to write information to or read data from that location. Within most HDDs, the magnetic read/write head is mounted on a slider. A slider generally serves to mechanically support the head and any electrical connections between the head and the rest of the disk drive system. The slider is aerodynamically shaped to glide over moving air in order to maintain a uniform distance from the surface of the rotating disk, thereby preventing the head from undesirably contacting the disk.

A slider is typically formed with an aerodynamic pattern of protrusions on its air bearing surface that enables the slider to fly at a constant height close to the disk during operation of the disk drive. A slider is associated with each side of each disk and flies just over the disk's surface. Each slider is mounted on a suspension to form a head gimbal assembly (HGA). The HGA is then attached to a semi-rigid actuator arm that supports the entire head flying unit. Several semi-rigid arms may be combined to form a single movable unit having either a linear bearing or a rotary pivotal bearing system.

The head and arm assembly is linearly or pivotally moved utilizing a magnet/coil structure that is often called a voice coil motor (VCM). The stationary portion of the VCM is mounted to a base plate or casting on which the spindle is also mounted. The base casting with its spindle, actuator VCM, and internal filtration system is then enclosed with a cover and seal assembly to ensure that no contaminants can enter and adversely affect the reliability of the slider flying over the disk. When current is fed to the motor, the VCM develops force or torque that is substantially proportional to the applied current. The arm acceleration is therefore substantially proportional to the magnitude of the current. As the read/write head approaches a desired track, a reverse polarity signal is applied to the actuator, causing the signal to act as a brake, and ideally causing the read/write head to stop and settle directly over the desired track.

The motor used to rotate the disk is typically a brushless DC motor. The disk is mounted and clamped to a hub of the motor. The hub provides a disk mounting surface and a means to attach an additional part or parts to clamp the disk to the hub. In most typical motor configurations of HDDs, the rotating part of the motor (i.e., the rotor) is attached to or is an integral part of the hub. The rotor includes a ring-shaped magnet with alternating north/south poles arranged radially and a ferrous metal backing. The magnet interacts with the motor's stator by means of magnetic forces. Magnetic fields and resulting magnetic forces are induced via the electric current in the coiled wire of the motor stator. The ferrous metal backing of the rotor acts as a magnetic return path. For smooth and proper operation of the motor, the rotor magnet magnetic pole pattern should not be substantially altered after it is magnetically charged during the motor's manufacturing process.

As hard disk drive performance requirements continue to increase, the thickness of the lubricant used on magnetic media has been required to become increasingly thinner. Currently, lubricant thickness on magnetic media is approximately 10 Å. Such thin layers of lubricant are difficult to achieve uniformly and difficult to reproduce on a consistent basis. FIG. 1 depicts a thickness-versus-concentration plot 11 that reveals a steep performance gradient, especially for the lubricant products Z-Tetraol S, Z-Tetetral GT, or ZTMD. This performance leads to processibility issues in media manufacturing using the conventional solvent HFE-7100, by 3M Company.

One solution to this problem is to utilize a different solvent, such as DuPont's Vertrel® XF, or Asahi Glass' AE-3000. The improved performance of these materials is shown in FIG. 2 by the plots 21, 23, respectively. Unfortunately, these options introduce significant additional solvent expenses, which can more than double the material costs. Still other options include the use of solvents with high molecular weights. However, heavy solvents do not adequately evaporate from the magnetic media and thus degrade flyability of sliders during operation of disk drives. Although each of these solutions is workable, an alternative solution that overcomes the issues and limitations of the prior art would be desirable.

### SUMMARY OF THE INVENTION

Embodiments of a system, method, and apparatus for a neat lubricant blend for magnetic recording media in hard disk drives are disclosed. The invention uses a neat lubricant blend that improves lubricant processibility without negatively impacting the performance of the magnetic media. For example, the lubricant blend may comprise a high bonding lubricant such as Z-Tetraol or ZTMD with a molecular weight of around 2000, and a low bonding lubricant such as Z-dol with a molecular weight that is below 1000. The two types of lubricant are selected such that they are miscible in their neat states, in contrast to mixtures using lubricants that have non-functional groups. The low molecular weight lubricant evaporates after lubrication, leaving only the high molecular weight lubricant behind. In this way media performance, such as lubricant pickup, is not adversely affected in any way.

In one embodiment, the invention comprises a method of fabricating magnetic recording media for a disk drive, including providing a disk having magnetic recording media; preparing a neat lubricant blend having a first lubricant with a high molecular weight and a second lubricant with a low molecular weight that is lower than the high molecular weight; mixing the first and second lubricants in their neat states without a solvent; adding the mixed first and second lubricants to a solvent to form a solution; applying the solution to the disk; and evaporating the second lubricant and the solvent from the disk such that only the first lubricant remains on the disk.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1 is a plot of conventional lubricants illustrating solution concentration versus lubricant thickness on media;

FIG. 2 is a plot of other conventional lubricants illustrating solution concentration versus lubricant thickness on media;

FIG. 3 is a plot of embodiments of lubricants illustrating total lubricant concentration versus final lubricant thickness on media, and is constructed in accordance with the invention;

FIG. 4 is a plot of one embodiment of a lubricant illustrating time after lubrication versus lubricant thickness on media, and is constructed in accordance with the invention; and

FIG. 5 is a schematic diagram of one embodiment of a disk drive constructed in accordance with the invention.

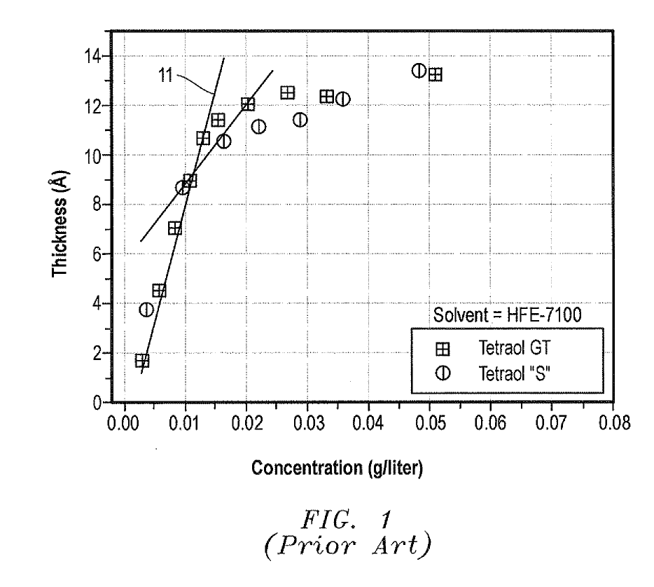

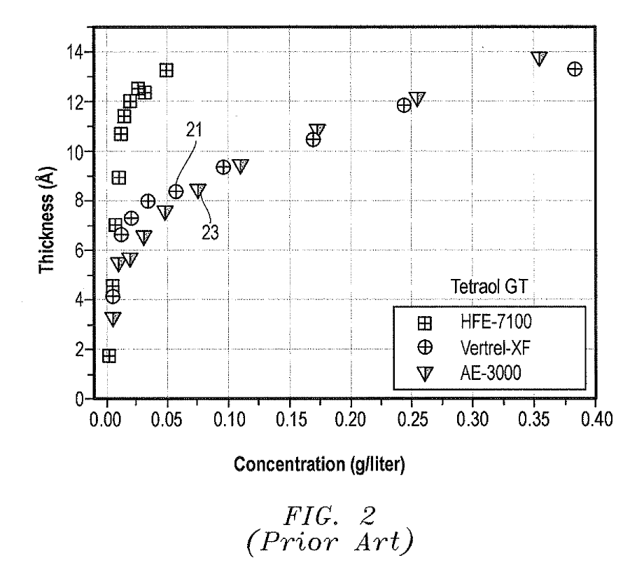

### DETAILED DESCRIPTION OF THE INVENTION

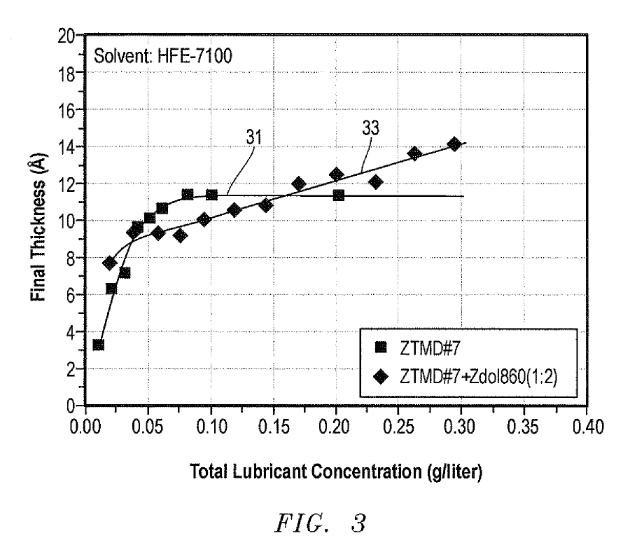

Referring to FIGS. 3-5, embodiments of a system, method and apparatus for a neat lubricant blend for magnetic recording media in hard disk drives are disclosed. The term “neat” means that the subject lubricant is undiluted with a solvent.

There are two aspects that make neat mixing of lubricants significant compared to mixing lubricants in solvent solutions. The first is ease of processing during manufacturing. A neat blend can be used in the same manner as a single type of lubricant, instead of dissolving two types of lubricants in solvents and then adjusting their ratio in a solution bath. Secondly, neat mixing of lubricants provides increased solubility. More of the first type of lubricant (e.g., ZTMD) can be dissolved in a solvent by first blending it with the second type of lubricant (e.g., Zdol) in their neat states, than by dissolving the first lubricant alone in the solvent. At an atomic level, the intermolecular hydrogen bonding among the extra hydroxyl groups on ZTMD (i.e., with 8 OH's) make it difficult to dissolve in a solvent. However, blending the ZTMD lubricant with the Zdol lubricant (i.e., with 2 OH's) weakens the intermolecular force of ZTMD, thereby increasing ZTMD's solubility when it is later mixed with a solvent.

Moreover, high molecular weight lubricants do not evaporate as readily as lightweight lubricants and, thus, do not degrade flyability of the sliders in hard disk drives. Conventionally, lubricant on the disks in hard drives has a molecular weight of about 2000 or more to avoid losing lubricant due to evaporation over the usable life of the hard drive. In one embodiment, such a lubricant is about 70 to 95% bonded to the disk surface, with the remaining portion being free and mobile for better durability. Too much free lubricant leads to lubricant transfer to the flying head (this is known as “lubricant (or lube) pickup”), thereby degrading the flyability and leading to read/write errors (i.e., hard drive failures). For these reasons it is beneficial to avoid introducing additional free lubricant with high molecular weight.

With some embodiments of the invention, only the high molecular weight lubricant is left behind after the light weight lubricant evaporates, so that lube pickup is not affected in any way. The low molecular weight lubricant is used to improve the processibility during lubricant dipping. It is easier to achieve the target thickness of the lubricant solution by adjusting the concentration in the lubricant bath.

Because of its lower number of functional groups (i.e., 2 OH's), the low weight lubricant is not bonded to the disk (i.e., it is a free lubricant) in some embodiments. If it remained on the disks, it would cause lubricant pickup by the head. Because of its low molecular weight, the lubricant evaporates from the disks after a relatively short period of time before the disks are built into hard drives. When the disks are ready to be put into the hard drives, the low molecular weight lubricant has evaporated, leaving only the high molecular weight lubricant on the disks. The high weight lubricant has more functional groups (i.e., 8 OH's) and, in some embodiments, is approximately 85% to 95% bonded to the disk. Thus, the “lube pickup” performance of the drive is not compromised or affected.

In one embodiment, ZTMD#7 is blended with a fractionated Zdol 860 (i.e., molecular weight 860) in a 1:2 ratio by weight in their neat states. The ZTMD#7 in HFE-7100 has a very limited solubility, making it impossible to reach a thickness on the media that is greater in height than 11.5 Å. In FIG. 3, a thickness versus concentration plot 31 is shown. At around 10 Å, the plot 11 has a steep slope, making it difficult to control the thickness of the solution below 11 Å. Consequently, ZTMD#7 cannot be used with HFE-7100 solvent. Instead of switching to an expensive solvent like Vertrel-XF, these problems may be solved using a ZTMD#7+Zdol 860 in a neat state blend, as demonstrated by plot 33 in FIG. 3.

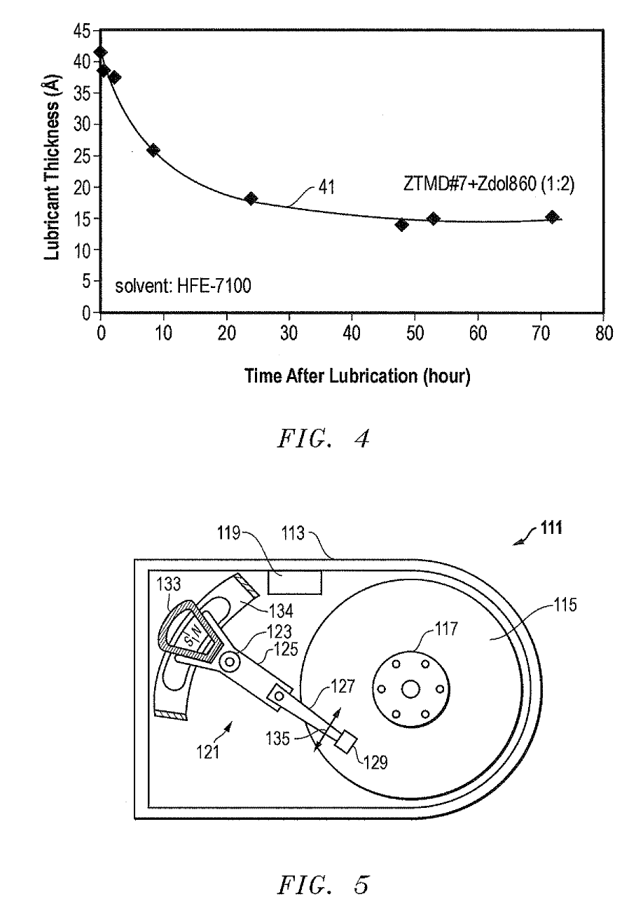

Other blending ratios or other high bonding lubricants such as Z-Tetraol also are workable. The lower molecular weight Zdol also may be used for its faster evaporation rate. Blends of other types of lubricant also are possible using the same method for improving processibility in lubricant dipping while not adversely impacting media performance. Plot 41 in FIG. 4 depicts the resultant lubricant thickness as the lower weighted lubricant component evaporates over time.

Accordingly, in one embodiment, the invention comprises a method of fabricating magnetic recording media for a disk drive. The method may comprise providing a disk having magnetic recording media; preparing a neat lubricant blend having a first lubricant with a high molecular weight and a second lubricant with a low molecular weight that is lower than the high molecular weight; mixing the first and second lubricants in their neat states without a solvent (e.g., in a 1:2 ratio); adding the mixed first and second lubricants to a solvent; and then applying the mixed solution to the disk. The method may then further comprise evaporating the second lubricant and solvent from the disk such that only the first lubricant remains on the disk.

In some embodiments, the low molecular weight may comprise approximately half (e.g., less than 1000) of the high molecular weight (e.g., approximately 2000). In other embodiments, the first lubricant may comprise Z-Tetraol or ZTMD (e.g., ZTMD fraction #7), the second lubricant may comprise Z-dol (e.g., fractionated Zdol 860, with molecular weight of 860), and the solvent may comprise HFE-7100. In some embodiments, approximately 70% to 90% of the first lubricant is bonded to the disk, with a remaining portion of the first lubricant being free and mobile on the disk. In other embodiments approximately 85% to 90% of the first lubricant is bonded to the disk.

Referring now to FIG. 5, a schematic drawing of one embodiment of an information storage system comprising a magnetic hard disk file or drive 111 for a computer system is shown. Drive 111 has an outer housing or base 113 containing at least one magnetic disk 115 that is constructed in accordance with the invention. Disk 115 is rotated by a spindle motor assembly having a central drive hub 117. An actuator 121 comprises one or more parallel actuator arms 125 in the form of a comb that is pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered load beam and suspension 127. A magnetic read/write transducer or head is mounted on a slider 129 and secured to a flexure that is flexibly mounted to each suspension 127. The read/write heads magnetically read data from and/or magnetically write data to disk 115. The level of integration called the head gimbal assembly is the head and the slider 129, which are mounted on suspension 127. The slider 129 is usually bonded to the end of suspension 127. The head is typically formed from ceramic or intermetallic materials and is pre-loaded against the surface of disk 115 by suspension 127.

Suspensions 127 have a spring-like quality which biases or urges the air bearing surface of the slider 129 against the disk 115 to enable the creation of the air bearing film between the slider 129 and disk surface. A voice coil 133 housed within a voice coil motor magnet assembly 134 is also mounted to arms 125 opposite the head gimbal assemblies. Movement of the actuator 121 (indicated by arrow 135) by controller 119 moves the head gimbal assemblies radially across tracks on the disk 115 until the heads settle on their respective target tracks.

While the invention has been shown or described in only some of its forms, it should be apparent to those skilled in the art that it is not so limited, but is susceptible to various changes without departing from the scope of the invention.

What is claimed is:

1. A method of fabricating magnetic recording media, comprising:
(a) providing a disk having magnetic recording media;
(b) preparing a neat lubricant blend having a first lubricant with a high molecular weight and a second lubricant with a low molecular weight that is lower than the high molecular weight;
(c) mixing the first and second lubricants in their neat states without a solvent;
(d) adding the mixed first and second lubricants to a solvent to form a solution; and then
(e) applying the solution to the disk.

2. A method according to claim 1, wherein the low molecular weight is approximately half of the high molecular weight.

3. A method according to claim 1, wherein the high molecular weight of the first lubricant is approximately 2000, and the low molecular weight of the second lubricant is less than 1000.

4. A method according to claim 1, wherein the first lubricant is selected from the group consisting of Z-Tetraol and ZTMD, the second lubricant is Z-dol, and the solvent is HFE-7100.

5. A method according to claim 1, further comprising, after step (e), evaporating the second lubricant and the solvent such that only the first lubricant remains on the disk.

6. A method according to claim 5, wherein approximately 70% to 95% of the first lubricant is bonded to the disk, with a remaining portion of the first lubricant being free and mobile on the disk.

7. A method according to claim 6, wherein approximately 85% to 95% of the first lubricant is bonded to the disk.

8. A method according to claim 1, wherein the first lubricant is ZTMD fraction #7, the second lubricant is fractionated Zdol, and the low molecular weight is approximately 860.

9. A method according to claim 8, wherein step (b) comprises mixing the first and second lubricants in a 1:2 ratio.

10. A method of fabricating magnetic recording media, comprising:
(a) providing a disk having magnetic recording media;
(b) preparing a neat lubricant blend having a first lubricant with a high molecular weight and a second lubricant with a low molecular weight that is approximately half of the high molecular weight;
(c) mixing the first and second lubricants in their neat states without a solvent;
(d) adding the mixed first and second lubricants to a solvent to form a solution;
(e) applying the solution to the disk; and then
(f) evaporating the second lubricant and the solvent such that only the first lubricant remains on the disk, wherein approximately 70% to 95% of the first lubricant is bonded to the disk, with a remaining portion of the first lubricant being free and mobile on the disk.

11. A method according to claim 10, wherein the high molecular weight of the first lubricant is approximately 2000, and the low molecular weight of the second lubricant is less than 1000.

12. A method according to claim 10, wherein the first lubricant is selected from the group consisting of Z-Tetraol and ZTMD, the second lubricant is Z-dol, and the solvent is HFE-7100.

13. A method according to claim 12, wherein approximately 85% to 95% of the first lubricant is bonded to the disk.

14. A method according to claim 10, wherein the first lubricant is ZTMD fraction #7, the second lubricant is fractionated Zdol, and the low molecular weight is approximately 860.

15. A method according to claim 14, wherein step (b) comprises mixing the first and second lubricants in a 1:2 ratio.

16. A method of fabricating a disk drive, comprising:
(a) providing an enclosure, a disk having magnetic recording media, and an actuator having a transducer for reading data from the magnetic recording media;
(b) preparing a neat lubricant blend having a first lubricant with a high molecular weight and a second lubricant with a low molecular weight that is lower than the high molecular weight;
(c) mixing the first and second lubricants in their neat states without a solvent;
(d) adding the mixed first and second lubricants to a solvent to form a solution;
(e) applying the solution to the disk;
(f) evaporating the second lubricant and the solvent such that only the first lubricant remains on the disk; and then
(g) mounting the disk and the actuator to the enclosure, such that both the disk and the actuator are movable relative to the enclosure.

17. A method according to claim 16, wherein the low molecular weight is approximately half of the high molecular weight.

18. A method according to claim 16, wherein the high molecular weight of the first lubricant is approximately 2000, and the low molecular weight of the second lubricant is less than 1000.

19. A method according to claim 16, wherein the first lubricant is selected from the group consisting of Z-Tetraol and ZTMD, the second lubricant is Z-dol, and the solvent is HFE-7100.

20. A method according to claim 19, wherein approximately 70% to 95% of the first lubricant is bonded to the disk, with a remaining portion of the first lubricant being free and mobile on the disk.

21. A method according to claim 20, wherein approximately 85% to 95% of the first lubricant is bonded to the disk.

22. A method according to claim 16, wherein the first lubricant is ZTMD fraction #7, the second lubricant is fractionated Zdol, and the low molecular weight is approximately 860.

23. A method according to claim 22, wherein step (b) comprises mixing the first and second lubricants in a 1:2 ratio.
